(19) United States
(12) Patent Application Publication
(10) Pub. No.: US 2024/0290530 A1
(43) Pub. Date: Aug. 29, 2024

(54) FORCED CONVECTION COOLING FOR MEDIUM FREQUENCY TRANSFORMERS INSIDE MEDIUM VOLTAGE CONVERTER CABINETS

(71) Applicant: ABB Schweiz AG, Baden (CH)

(72) Inventor: Uwe Drofenik, Baden (CH)

(21) Appl. No.: 18/566,237

(22) PCT Filed: Jun. 1, 2022
(86) PCT No.: PCT/EP2022/064963

§ 371 Date: Dec. 1, 2023

(30) Foreign Application Priority Data
Jun. 2, 2021 (EP) 21177413.8

(51) Int. Cl. H01F 27/08; H01F 27/02

(52) U.S. Cl. CPC H01F 27/085; H01F 27/025

(57) ABSTRACT

A transformer arrangement is provided. The transformer arrangement includes a plurality of stacked transformers, each transformer including a transformer core, a first winding wound around the transformer core, a second winding, a spatial gap configured to allow a cooling of the transformer by a coolant fluid flowing in the spatial gap, and a support structure supporting the transformers in the plurality of stacked transformers, wherein the support structure and the spatial gaps of the transformers in the plurality of stacked transformers are configured to form a cooling duct for the coolant fluid.

### CROSS REFERENCE TO RELATED APPLICATIONS

This patent application is a National Stage Entry of PCT/EP2022/064963 filed on Jun. 1, 2022, which claims the benefit and priority of European Patent Application No. 21177413.8 filed on Jun. 2, 2021, the disclosures of which are incorporated by reference herein in their entirety as part of the present application.

### BACKGROUND

The present disclosure relates to transformer arrangements and to a method for cooling a transformer arrangement.

Solid State Transformers (SST) employ power electronics to operate so-called medium frequency transformers (MFT).

For example, an SST may receive a medium voltage three-phase AC input with a frequency of 50 Hz and transform said input to a low voltage three-phase AC output with a frequency of 50 Hz using a plurality of converters and medium frequency transformers or vice versa. For example, the 50 Hz AC input may be converted by a plurality of input converters to medium frequency AC signals having a frequency in the range of several kHz to several tens of kHz. For example, the medium frequency AC signals are then applied to medium frequency transformers connected to output converters that finally produce the AC output at 50 Hz. The input converters and the output converters may be formed by solid state power electronic components that convert an AC signal to an AC signal of different frequency making use of an intermediate DC link to store energy during the conversion. For example, the output converters may share a common DC link. Medium frequency transformers are smaller when compared to transformers at low frequency. A typical SST may include a plurality of converter cells, each converter cell receiving an AC signal at low frequency, converting said low frequency AC signal to a medium frequency AC signal, transforming said medium frequency AC signal from a higher voltage to a lower voltage or vice versa with a medium frequency transformer and finally converting the output of the medium frequency transformer to a low frequency again and/or to a DC voltage for a final conversion to a low frequency AC signal via a DC link and a final inverter.

A typical SST includes many converter cells adequately connected to obtain the desired voltages and/or currents. For example, a plurality of input converters may be connected in series to handle a higher input voltage, each converter powering a medium frequency transformer that supplies power to a respective AC to DC converter stage powering a common output DC link coupled to a final output inverter (or vice versa for a transformation from lower voltages to higher voltages).

A Solid State Transformer is described for example in J. Huber, J. W. Kolar, “Common-Mode Currents in Multi-Cell Solid-State Transformers”, Proceedings of the International Power Electronic Conference, ECCE Asia (IPEC 2014), Hiroshima, Japan, May 18-21, 2014.

It is difficult to cool and insulate the medium frequency transformers of a Solid State Transformer.

An arrangement of the medium frequency transformers of a Solid State Transformer that improves the cooling of the transformers is therefore demanded.

### BRIEF DESCRIPTION

The disclosure is defined by the independent claims. The dependent claims define further embodiments of the disclosure.

### BRIEF DESCRIPTION OF THE DRAWINGS

FIG. 1 illustrates a transformer arrangement according to some embodiments of the present disclosure.

FIG. 1A illustrates a transformer according to some embodiments of the present disclosure.

FIG. 1B illustrates a transformer arrangement according to some embodiments of the present disclosure.

FIG. 2 illustrates a transformer arrangement without cooling duct and a temperature of said arrangement.

FIG. 3 illustrates a transformer arrangement according to the present disclosure.

### DETAILED DESCRIPTION

Solid State Transformers (SST) are medium voltage (MV) converters which employ power electronics to operate medium frequency transformers (MFT) at frequencies typically higher than 50 Hz in order to shrink the transformer size.

The medium frequency transformers may for example be operated in the range from 5 kHz to 30 kHz, in particular for example at 20 KHz. The Solid State Transformers may for example convert a medium voltage (MV) to a low voltage (LV) or vice versa, for example the solid state transformer may convert a medium voltage typically in the range between 10 kV and 50 KV or higher to a low voltage up to 1 kV or vice versa. The medium voltage may be for example between 10 KV and 50 kV or between 10 KV and 100 kV. For example, the medium voltage may be 10 kV or 20 kV or 30 kV or 50 kV or 100 kV or more than 100 kV.

Typical applications of SSTs are in electric grids and power plants related to renewable energy, like for example in grids powered by solar and/or wind power, and/or in storage systems, like system including a battery and/or a fuel cell and/or hydrogen production. SSTs may also be used for charging electric vehicles and in datacenters.

A Solid State Transformer (SST) typically includes a plurality of converter cells with a medium frequency transformer for each cell. Medium frequency transformers are smaller in size than transformers operating at 50 Hz or 60 Hz with comparable electrical characteristics. An efficient cooling of the medium frequency transformers is challenging due a plurality of reasons:

It is difficult to cool the medium frequency transformers due to the smaller size of said transformers when compared to transformers operating at for example 50 Hz or 60 Hz.

It is difficult to guarantee the insulation of the higher voltage winding to which the MV is applied in a medium frequency transformer.

It is difficult to efficiently use the cooling capabilities of a coolant due to the difficulties of achieving a sufficiently effective coolant flow.

Providing a fan and/or a dedicated cooling system for each medium frequency transformer increases the size, the complexity and the cost of the SST.

Cooling the medium frequency transformer together with the power electronic solid state components of the converter cells results in a heat exchange between the medium frequency transformers and the solid state components which may be disadvantageous in terms of stability and efficiency.

The present disclosure describes a design for an optimized medium frequency transformer cooling under the constraint of guaranteeing medium voltage insulation (including line insulation at 75 kV or higher) by placing MFTs in a special cooling duct which is thermally decoupled from the power converters of the SST. The MFTs may be grouped according to any convenient grouping in an arrangement for a solid state transformer. In some embodiments, a plurality of cooling ducts may be present, each cooling duct cooling a stack of MFTs.

For example, 6 MFTs may be stacked with 1 cooling duct for cooling the 6 MFTs or, alternatively, 6 MFTs may be grouped in two groups/stacks, each group/stack including 3 MFTs and a cooling duct, thereby resulting in 2 cooling ducts (one for each group/stack) cooling the 6 MFTs.

In some embodiments, any number of MFTs may be conveniently arranged to be cooled by a convenient number of cooling ducts.

Transformer arrangement of the present disclosure may be combined with other transformer arrangement according to the present disclosure and/or already known in the art to produce an arrangement with a greater number of transformers part of a solid state transformer with more convenient characteristics, e.g. with higher ratings for currents and/or voltages. Transformers in a plurality of transformer arrangements according to the present disclosure may be combined to be connected in series and/or parallel, resulting in higher currents and/or voltages. One or more cooling ducts may cool one or more groups of transformers.

The present disclosure enables efficient and low-cost cooling of medium voltage SST, providing a simple setup for cooling and for medium voltage insulation at minimum complexity.

Solid State Transformers employ power electronics to operate medium frequency transformers operating at a frequency that is higher than 50 Hz, for example at a frequency of several kHz or tens of kHz, for example at a frequency in the range between 5 kHz and 30 kHz, for example 20 kHz. SST are used to replace 50 Hz distribution transformers. For example, an SST may be used for transferring a power of several MW to a medium voltage (MV) AC grid with medium frequency transformers that are much smaller than 50 Hz transformers. The smaller size of the medium frequency transformers results in a smaller footprint, lower weight, and cost reduction due to less material cost. Typical applications involve solar and/or wind renewable energy distribution, batteries, fuel cells and/or hydrogen based storage systems, electric vehicle charging and datacenters.

A typical SST consist of many converter cells, typically employing low voltage (LV) power electronics at low cost. The converter cells are connected in series and/or in parallel to achieve the desired voltages and currents. The medium frequency transformers typically provide the galvanic insulation of the medium voltage circuit from the low voltage circuit and/or from ground. A large number of low voltage converter cells may be connected in series to handle an overall medium voltage potential difference (either as output or as input of the solid state transformer). For example, in a 10 kV grid, more than ten 1 kV converter cells per phase are required, resulting in a total of more than 30 converter cells, each cell containing one medium frequency transformer, where each medium frequency transformer requires bushings and distancing for an adequate insulation of the medium voltage from the low voltage and/or from ground.

The losses in an MFT are comparable to the losses in a 50 Hz transformer, but the size of an MFT is significantly smaller than the size of a 50 Hz transformer with a typical weight reduction by a factor 5 and more. The cooling of an MFT is significantly more difficult than the cooling of a 50 Hz transformer because of reduced surfaces.

MFTs have to provide medium voltage insulation, therefore a cooling system has to take into account very high electrical fields and high magnetic field variations. A cooling system with metallic components has to be placed with care in order to avoid eddy currents.

It is difficult to attach a heat sink in a reliable way to an MFT because most surfaces, especially coils of the MFT, are usually not flat. Furthermore, heat sinks and/or metallic fins might heat up significantly in the vicinity of the MFT due to eddy currents induced by the electromagnetic fields in the MFT.

Inside an SST converter cabinet there is typically a plurality of MFTs that have to be cooled while taking medium voltage insulation coordination into account.

When power electronics of the SST is thermally coupled with the MFT and each converter cell employs its own cooling system, the arising complexity results in an increase of the size and the cost of the converter cell up to a point where the SST is not competitive with conventional transformers.

The present disclosure advantageously places a plurality of medium frequency transformers in contact with a cooling duct decoupled from the power converters of the converter cells. The cooling duct allows a maximum power density of the MFTs under the requirement of galvanic insulation of the medium voltage, while simultaneously optimizing a cooling of the MFTs avoiding a separate cooling system for each MFT in the SST.

The present disclosure relates to a transformer arrangement, in particular to a transformer arrangement of medium frequency transformers part of a solid state converter.

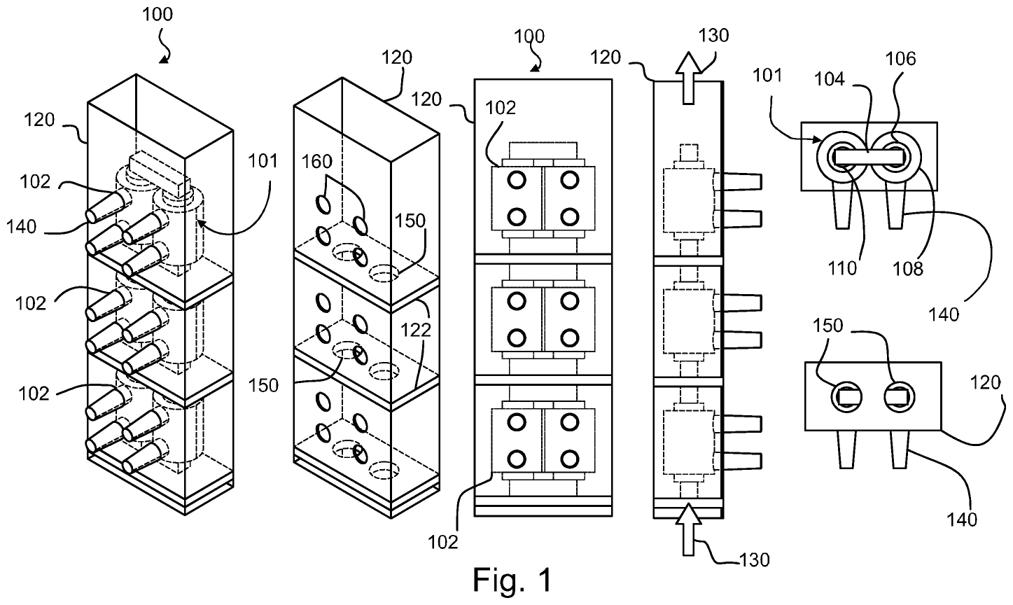

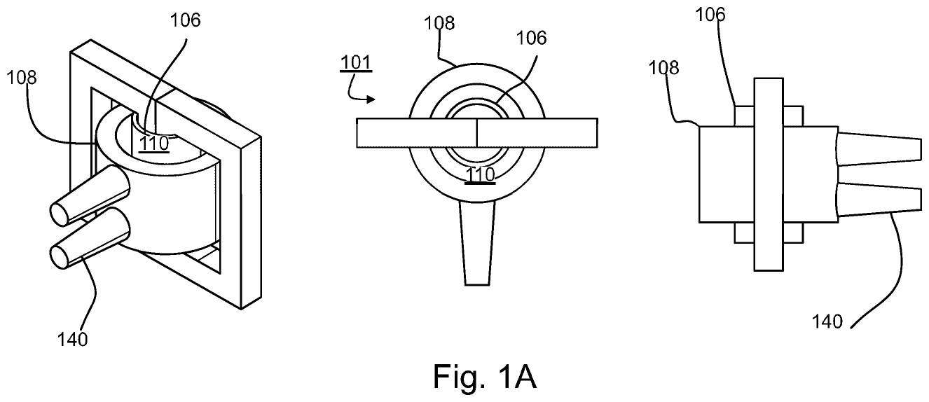

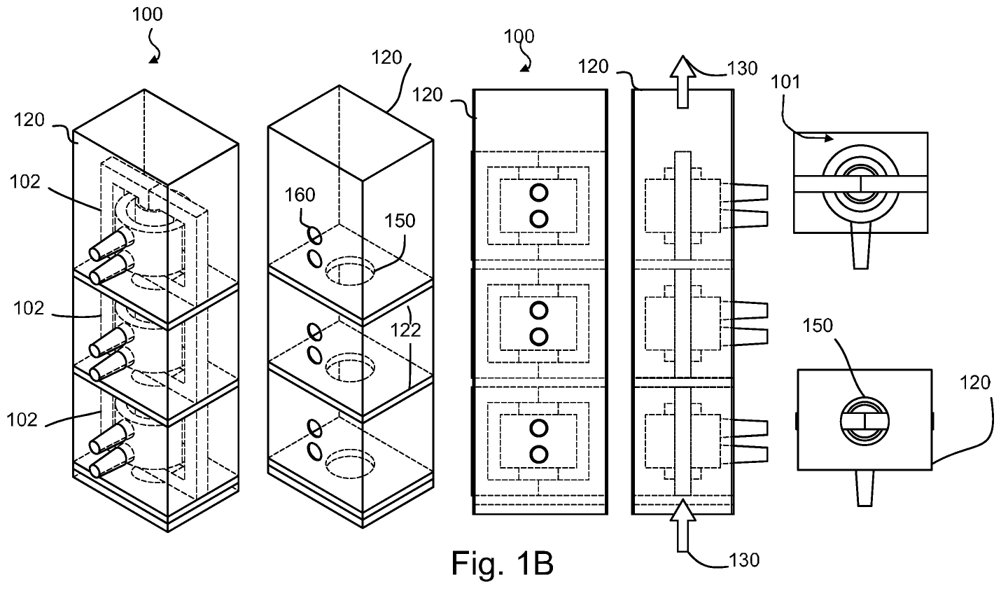

FIG. 1 illustrates a transformer arrangement 100 according to some embodiments of the present disclosure.

According to the present disclosure, a transformer arrangement 100 is provided, the transformer arrangement includes a plurality 102 of stacked transformers, each transformer 101 including a transformer core 104, a first winding 106 wound around the transformer core, a second winding 108, a spatial gap 110 configured to allow a cooling of the transformer by a coolant fluid flowing in the spatial gap, and a support structure 120 supporting the transformers in the plurality of stacked transformers, wherein the support structure and the spatial gaps of the transformers in the plurality 102 of stacked transformers are configured to form a cooling duct 130 for the coolant fluid.

The cooling duct is thereby in contact with the plurality of stacked transformers allowing for an efficient cooling. The first winding and/or the second winding of the transformers in the plurality of stacked transformers may have an axis oriented in parallel to an axis of the cooling duct and parallel to a flow direction of the coolant fluid.

The support structure 120 may include vertical walls and/or horizontal separation plates 122 between transformers in the plurality of stacked transformers. The horizontal separation plates 122 of the support structure 120 may have openings 150 to allow the flow of coolant fluid between the spatial gaps of adjacent transformers. The openings 150 may for example have a circular shape or the shape of a circular ring. The flow of coolant is thereby guided by the circular holes into and through the spatial gaps of the transformers in the plurality of stacked transformers.

The stacked transformers are typically MFTs of an SST contained in a cabinet.

An air inlet may be present at the bottom of the cabinet and a fan on top of the cabinet and/or of the transformer arrangement may produce forced convection cooling. The cooling duct is thermally decoupled from other components inside the cabinet, like e.g., power electronic converters and/or solid state devices.

In some embodiments the coolant is air.

In FIG. 1, for each transformer 101 in the plurality 102 of stacked transformers the first winding 106 and the second winding 108 are both split into two coils forming a first winding first coil, a first winding second coil, a second winding first coil, and a second winding second coil, and each of the second winding first coil and second winding second coil has two bushings 140 extending away from the transformer core, in particular all the bushings may be substantially parallel to each other and extending away from the transformer core 104.

FIG. 1A illustrates a transformer according to some embodiments of the present disclosure. In FIG. 1A, the transformer 101 has a second winding 108 with two bushings that is formed by a single coil.

FIG. 1B shows a transformer arrangement 100 where the plurality 120 of stacked transformers is formed by transformers 101 as described in FIG. 1A.

The transformers may have coils with high voltage bushings extending away from the transformer core, in particular perpendicular to the coil axis and/or perpendicular to the air flow direction.

The support structure may have openings 160 for the high voltage bushings that may be connected with the bushings to form an air-tight connection to avoid the leakage of air through the openings 160 for the bushings. The bushings 140 allow a connection of the MFT HV-coils to the converters outside the cooling duct at the medium voltage side of the cabinet.

The support structure 120 may be made of non-conductive material. For example, the cooling duct and/or the horizontal separation plates 122 may be formed employing electrically non-conductive plates in order to avoid eddy currents due to the high frequency and large magnetic stray fields in the vicinity of the MFTs.

All the transformer cores are typically at ground potential.

In addition to the fan 170 at the top, one fan 172 per MFT blowing from a side may be present, the fan being attached to walls of the support structure opposite to a wall containing openings for the bushings.

The present disclosure therefore allows efficient and simple low-cost cooling of MV SST converters.

The present disclosure provides a simple setup for cooling and insulating MVT at a minimum of complexity.

The present disclosure allows maximizing MFT power ratings in a SST targeting the hot spots of the MFTs in the gaps between an inner winding and the core with an adequate coolant flow.

In some embodiments of the present disclosure, the transformer arrangement further includes solid state converters to form a solid state transformer (SST), wherein the transformers in the plurality of stacked transformers are configured to be operated at frequencies between 1 KHz and 100 kHz, in particular between 5 kHz and 30 kHz, in particular at 20 kHz, and wherein the transformer arrangement is configured such that the coolant fluid exclusively cools the transformers in the plurality of stacked transformers. In particular the coolant fluid may not cool solid state components (like for example IGBTs, transistors, etc.) of the solid state transformer.

A single fan for a larger number of MFTs in an SST can be employed.

The cooling duct is thermally decoupled from power electronic components of the SST. The present disclosure therefore allows a thermal decoupling of the MFT cooling duct from cooling systems of other SST components like the solid state components for example included in a converter in a cabinet of the SST.

In some embodiments, for each transformer in the transformer arrangement, bushings may extend away from the transformer cores of the transformers. All the bushings may be parallel to each other and extending in the same direction. The bushings allow an electric connection of the MFT windings at higher potential to converters of the SST. The bushings may extend through air-tight openings in vertical walls of the support structure. When all the bushings extend in the same direction the connections to the converters in the SST at medium voltage potential are simple and clearly arranged.

Transformer arrangements according to embodiments of the present disclosure may form building blocks for may be increasing the power in an SST by connecting in series and/or in parallel several transformers in the transformer arrangements inside a cabinet. Therefore, a plurality of transformer arrangements of the present disclosure may be connected to each other and/or to solid state converters to form series and/or parallel connections of transformers forming an overall solid state transformer with increased voltage and/or current rating. For example, one or more transformer arrangements according to the present disclosure may be present for each phase of a three-phase SST.

Several MFTs coupled to the cooling duct of the present disclosure can be seen as building blocks for may be increasing the power by electrically paralleling or series-connecting such wind tunnel configurations inside a cabinet of the SST.

In some embodiments, small additional openings in the horizontal separation plates are present in order to increase a volume of the coolant, in particular of cooling air.

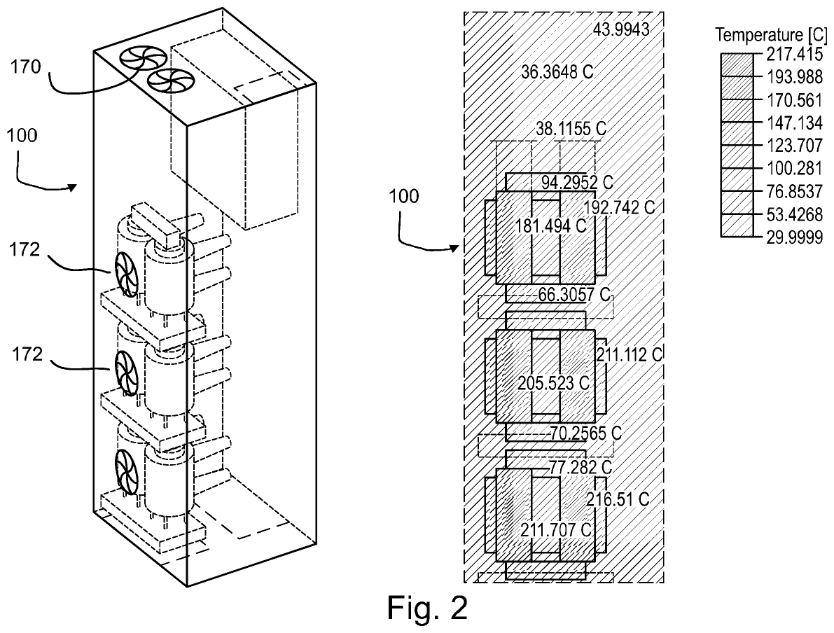

FIG. 2 illustrates a transformer arrangement without cooling duct and a temperature of said arrangement. Although there is air available from all sides and a fan at the top, the temperatures of the MFTs typically reach about 220° C. or more in a configuration of 2 m of height for a converter operation at 10 kV/1 MW with core losses per MFT of about 500 W, low voltage winding losses per MFT of 462 W and high voltage winding losses per MFT of 575 W.

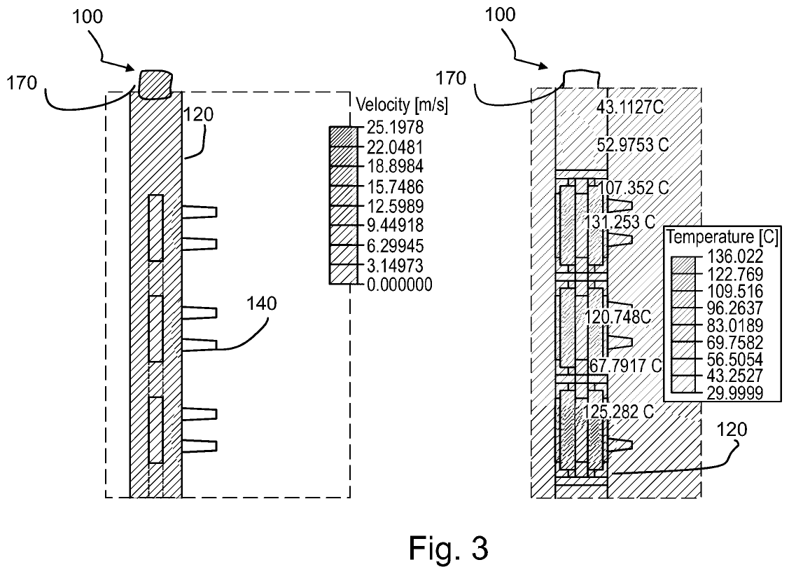

FIG. 3 illustrates a transformer arrangement according to the present disclosure operating with similar parameters as the arrangement of FIG. 2. The maximum temperature of the MFTs remains below 140° C.

FIG. 3 shows that the coolant flow, in particular an air flow, is concentrated in the cooling duct and the MFTs are thermally decoupled from the power electronics inside the cabinet. The maximum temperatures inside the MFT remain below 140° C. The whole configuration is 2 m high.

FIG. 3 further illustrates a velocity of the air as cooling fluid, showing that the air flow is concentrated in the cooling duct with a uniform velocity.

The present disclosure provides a transformer arrangement 100 including a plurality 102 of stacked transformers, each transformer 101 including a transformer core 104, a first winding 106 wound around the transformer core, a second winding 108, a spatial gap 110 configured to allow a cooling of the transformer by a coolant fluid flowing in the spatial gap, and a support structure 120 supporting the transformers in the plurality of stacked transformers, wherein the support structure 120 and the spatial gaps of the transformers in the plurality of stacked transformers are configured to form a cooling duct 130 for the coolant fluid.

In some embodiments, the transformer arrangement is configured such that the coolant fluid flows sequentially through each of the spatial gaps of the transformers in the plurality of stacked transformers.

In some embodiments, a voltage difference between the first winding and the transformer core is lower than a voltage difference between the second winding and the transformer core, and the spatial gap is located between the transformer core and the first winding, and/or the spatial gap is located between the first winding and the second winding.

In some embodiments, the second winding is wound around the first winding.

In some embodiments, for each transformer the first winding and the second winding are both split into two coils forming a first winding first coil, a first winding second coil, a second winding first coil, and a second winding second coil, and each of the second winding first coil and second winding second coil has two bushings 140 extending away from the transformer core, in particular where all the bushings 140 are substantially parallel to each other and extending away from the transformer core 104.

In some embodiments, for each transformer the second winding is formed by a coil having two bushings 140, in particular the two bushings may be parallel and extending away from the transformer core 104.

In some embodiments, the support structure 120 includes vertical walls and/or horizontal separation plates 122 between transformers 101 in the plurality 102 of stacked transformers, the horizontal separation plates 122 having openings 150 to allow a flow of coolant fluid between the spatial gaps 110 of the transformers, in particular wherein the openings 150 match a section of the spatial gaps 110, in particular wherein the openings have the shape of a circle or of a circular ring.

In some embodiments, the support structure is made from electrically non-conductive material.

In some embodiments, the transformer structure further includes at least one fan 170 at the top for producing a flow of air flowing through the spatial gaps 110 of the transformers, and the coolant fluid is air.

In some embodiments, the support structure has openings 160 for high voltage bushings 140, in particular for parallel high voltage bushings 140 extending away from the transformer cores 104 and coupled to a second winding of the transformers, in particular wherein the openings are in vertical walls of the support structure 120.

In some embodiments, the openings 160 for the high voltage bushings are configured to form an air-tight connection with the bushings 140 to avoid the leakage of air through the openings.

In some embodiments, the support structure further includes one lateral fan 172 per transformer attached to the wall of the support structure 120 opposite to the openings 160 for the high voltage bushings, and the transformer arrangement is configured such that the lateral fans blow air that flows into the spatial gaps 110 of the transformers in the cooling duct 130.

In some embodiments, the support structure includes auxiliary openings configured to increase a volume of cooling air flowing in the spatial gaps of the transformers and/or around the transformers in the arrangement, in particular the auxiliary openings are located in horizontal separation plates between transformers.

In some embodiments, the transformer arrangement further includes helicoidal guides for each transformer, the helicoidal guides configured and shaped for cooling the transformers and placed in the spatial gaps such that the coolant fluid is guided by the helical guide in the spatial gap, the coolant being in direct contact with the transformer core and/or with the first winding.

In some embodiments, the transformer arrangement further includes solid state converters to form a solid state transformer, wherein the transformers in the plurality of stacked transformers are configured to be operated at frequencies between 1 kHz and 100 kHz, in particular between 5 kHz and 30 kHz, in particular at 20 kHz, and wherein the transformer arrangement is configured such that the coolant fluid exclusively cools the transformers in the plurality of stacked transformers.

The present disclosure further provides a method for cooling a transformer arrangement according to the present disclosure, the method including flowing a coolant in the cooling duct, the coolant sequentially flowing into the spatial gaps of the transformers in the plurality of stacked transformers.

1. A transformer arrangement comprising:
a plurality of stacked transformers, each transformer including
a transformer core;
a first winding wound around the transformer core;
a second winding; and
a spatial gap configured to allow a cooling of the transformer by a coolant fluid flowing in the spatial gap; and
a support structure supporting the transformers in the plurality of stacked transformers,
wherein the support structure and the spatial gaps of the transformers in the plurality of stacked transformers are configured to form a cooling duct for the coolant fluid, and
wherein the support structure comprises vertical walls and horizontal separation plates between transformers in the plurality of stacked transformers, the horizontal separation plates having openings to allow a flow of coolant fluid between the spatial gaps of the transformers, wherein the openings match a section of the spatial gaps.

2. The transformer arrangement of claim 1, wherein the coolant fluid flows sequentially through each of the spatial gaps of the transformers in the plurality of stacked transformers.

3. The transformer arrangement of claim 1, wherein a voltage difference between the first winding and the transformer core is lower than a voltage difference between the second winding and the transformer core,
wherein the spatial gap is located between the transformer core and the first winding, or
wherein the spatial gap is located between the first winding and the second winding, or
wherein the spatial gap is located between the transformer core and the first winding and between the first winding and the second winding.

4. The transformer arrangement of claim 1, wherein the second winding is wound around the first winding.

5. The transformer arrangement of claim 1, wherein for each transformer the first winding and the second winding are both split into two coils forming a first winding first coil, a first winding second coil, a second winding first coil, and a second winding second coil, and wherein each of the second winding first coil and second winding second coil has two bushings extending away from the transformer core.

6. The transformer arrangement of claim 1, wherein for each transformer the second winding is formed by a coil having two bushings.

7. (canceled)

8. (canceled)

9. The transformer arrangement of claim 1, further comprising at least one fan at the top configured to produce a flow of air flowing through the spatial gaps of the transformers, and wherein the coolant fluid is air.

10. The transformer arrangement of claim 1, wherein the support structure has openings for high voltage bushings.

11. The transformer arrangement of claim 10, wherein the openings for the high voltage bushings are configured to form an air-tight connection with the bushings to avoid the leakage of air through the openings.

12. The transformer arrangement of claim 10, wherein the support structure further comprises one lateral fan per transformer attached to the wall of the support structure opposite to the openings for the high voltage bushings, and wherein the transformer arrangement is configured such that the lateral fans blow air that flows into the spatial gaps of the transformers in the cooling duct.

13. The transformer arrangement of claim 1, wherein the support structure includes auxiliary openings configured to increase a volume of cooling air flowing in the spatial gaps of the transformers or around the transformers in the arrangement or in the spatial gaps of the transformers and around the transformers in the arrangement.

14. The transformer arrangement of claim 1, further comprising helicoidal guides for each transformer, the helicoidal guides configured and shaped for cooling the transformers and placed in the spatial gaps such that the coolant fluid is guided by the helical guide in the spatial gap, the coolant being in direct contact with the transformer core or with the first winding or with the transformer core and the first winding.

15. The transformer arrangement of claim 1, further comprising solid state converters to form a solid state transformer, wherein the transformers in the plurality of stacked transformers are configured to be operated at frequencies between 1 kHz and 100 kHz, and wherein the transformer arrangement is configured such that the coolant fluid exclusively cools the transformers in the plurality of stacked transformers.

16. A method for cooling a transformer arrangement, the transformer arrangement including:
a plurality of stacked transformers, each transformer including
a transformer core;
a first winding wound around the transformer core;
a second winding; and
a spatial gap configured to allow a cooling of the transformer by a coolant fluid flowing in the spatial gap; and
a support structure supporting the transformers in the plurality of stacked transformers,
wherein the support structure and the spatial gaps of the transformers in the plurality of stacked transformers are configured to form a cooling duct for the coolant fluid, and
wherein the support structure includes vertical walls and horizontal separation plates between transformers in the plurality of stacked transformers, the horizontal separation plates having openings to allow a flow of coolant fluid between the spatial gaps of the transformers, wherein the openings match a section of the spatial gaps; and
the method comprising:
flowing a coolant in the cooling duct, the coolant sequentially flowing into the spatial gaps of the transformers in the plurality of stacked transformers.

17. The transformer arrangement of claim 1, wherein the openings have a shape of a circle or of a circular ring, or
wherein the support structure is made from electrically non-conductive material, or
wherein the openings have the shape of a circle or of a circular ring and the support structure is made from electrically non-conductive material.

18. The transformer arrangement of claim 1, wherein for each transformer the first winding and the second winding are both split into two coils forming a first winding first coil, a first winding second coil, a second winding first coil, and a second winding second coil, and wherein each of the second winding first coil and second winding second coil has two bushings extending away from the transformer core, and wherein all the bushings are substantially parallel to each other and extend away from the transformer core.

19. The transformer arrangement of claim 1, wherein for each transformer the second winding is formed by a coil having two bushings, and wherein the two bushings are parallel and extend away from the transformer core.

20. The transformer arrangement of claim 1, wherein the support structure has openings for parallel high voltage bushings extending away from the transformer cores and coupled to a second winding of the transformers, and wherein the openings are in vertical walls of the support structure.

21. The transformer arrangement of claim 1, wherein the support structure includes auxiliary openings configured to increase a volume of cooling air flowing in the spatial gaps of the transformers, or around the transformers in the arrangement, or both in the spatial gaps of the transformers and around the transformers in the arrangement, and wherein the auxiliary openings are located in horizontal separation plates between transformers.

22. The transformer arrangement of claim 1, further comprising solid state converters to form a solid state transformer, wherein the transformers in the plurality of stacked transformers are configured to be operated at frequencies between 5 kHz and 30 kHz, and wherein the transformer arrangement is configured such that the coolant fluid exclusively cools the transformers in the plurality of stacked transformers.
